(19) United States
(12) Patent Application Publication
(10) Pub. No.: US 2011/0013999 A1
(43) Pub. Date: Jan. 20, 2011

(54) DRILL

(75) Inventors: Steven Moseley, Feldkirch-Tisis (AT); Roland Foser, Schaan (LI); Guenther Domani, Frastanz (AT); Jan Allaart, Eschen (LI)

Correspondence Address: CROWELL & MORING LLP;INTELLECTUAL PROPERTY GROUP, P.O. BOX 14300, WASHINGTON, DC, 20044-4300, US

(73) Assignee: Hilti Aktiengesellschaft, Schaan (LI)

(21) Appl. No.: 12/783,110

(22) Filed: May 19, 2010

(30) Foreign Application Priority Data
May 20, 2009 (DE) 10 2009 003 288.6

(51) Int. Cl. B23B 51/02

(52) U.S. Cl. 408/226; 408/199

(57) ABSTRACT

A drill is disclosed. The drill includes a drill head made of hard metal and a shank made of steel to which the underside of the drill head is fastened integrally. The underside is curved inwardly in a cone-shaped manner.

### This application claims the priority of German Patent Document No. 10 2009 003 288.6, filed May 20, 2009, the disclosure of which is expressly incorporated by reference herein.

### BACKGROUND AND SUMMARY OF THE INVENTION

The present invention relates to a drill with a full head, which is suitable for a turning/chiseling operation in particular.

Drills for the building and construction industry are manufactured with cutting edges made of hard metal. The hard metal, typically a sintered tungsten carbide, is hard enough to cut rock as well as steel reinforcements. In the case of a full head drill, the entire drill head is manufactured of the hard metal. The drill head is connected to a helix at a joining zone. The joining zone represents a weak point in the transmission of forces from the helix to the drill head and also from the drill head to the helix. In particular, the drill heads can get sheared or twisted off the helix if the drill head jams on a reinforcement during drilling.

An objective of the present invention is a more stable fastening of the full head to a shank of a drill.

It was recognized that the drill head has intrinsic stress, which releases over the joining zone. As a result, this stress contributes to weakening the drill.

According to one aspect of the invention, a drill is comprised of a drill head made of hard metal and a shank made of steel to which the underside of the drill head is fastened integrally. The underside is curved inwardly in a cone-shaped manner. The drill features a uniform thickness to a large extent, which was recognized as producing a reduction in intrinsic stress in the drill head.

One embodiment provides that the underside is cone-shaped. A slope of the underside may deviate from a slope of a cutting edge of the drill head by less than 20 degrees. A material thickness may be configured to be constant preferably over a large area of the drill head, in particular in the plane of the cutting edges. As a result, a drill head may be manufactured with a high internal strength and stability.

One embodiment provides for a surface of the shank facing the drill head to have a convex curvature. The convex curvature may represent at least 80 percent or the entire cross section of the shank.

One embodiment provides that the underside of the drill head is roughed with multiple depressions and/or elevations, the height of which is a maximum of 15 percent, preferably a maximum of 10 percent of a height of the drill head.

The depressions/elevations interrupt the otherwise flat structure of the full head with the shank. A crack propagation could be suppressed effectively hereby, because it is suspected that a crack must run either in one plane through different material or within one material in different crystallographic planes. Starting at a height of 15 percent, there was no improvement in behavior with respect to crack propagation. The expense of manufacturing a mechanically stable underside of the drill head from the hard metal with the multiple elevations and/or depressions increases significantly with the height of the elevations and depressions. A height in the range of 5 percent to 10 percent is preferred based on a good crack suppression and a mechanically stable underside. The elevations and depressions are preferably greater than typical surface roughnesses in the range of less than 0.05 mm

One embodiment provides that the underside is connected integrally to the shank. The integral connection can be produced by directly welding the shank to the drill head. Alternatively, a thin film made of an auxiliary material or a soldering material is used for the connection.

One embodiment provides that a ratio of a width of the depressions and/or elevations to their height is greater than 0.5, preferably 0.75 and/or less than 4, preferably 3. Depressions with a considerably smaller width than height are a small impediment for a crack. The elevations simply break off. If the width exceeds a specific size, the crack can propagate unimpeded along an unstressed crystallographic plane in the depression or the elevation. A radius of curvature of the surfaces of the depressions and/or elevations should be greater than 0.1 mm in each direction. Edges or tips simply tend to break off when a crack is initiated. As a result, they do not represent an effective barrier. Pyramid-shaped depressions and elevations are preferably rounded off on the edges and the tip.

One embodiment provides that the depressions and/or elevations are arranged along an annular line, which runs centered to the longitudinal axis of the drill. The depressions and/or elevations may be arranged along multiple annular lines arranged concentrically to one another. An annular line describes a self-contained line, the shape of which may be circular or elliptical, but is not limited to these two shapes. The depressions and/or elevations may themselves be configured to be annular or be interrupted along the line. An interrupted depression therefore is made up of multiple individual depressions, which are aligned along the annular line. The annular line may divide a radial distance from an edge of the drill head to an axis of the drill in a constant ratio.

One embodiment provides that the depressions and/or elevations are arranged on grid points. The grid points are the intersections of the grid lines. The grid is defined by grid lines respectively running parallel in two directions. The drill head may have two cutting edges and the first grid lines run parallel to the first cutting edge and the second grid lines run parallel to the second cutting edge. The depressions and/or elevations may be interrupted along the grid lines.

The drill can have a shank with a helix.

The following description explains the invention on the basis of exemplary embodiments and figures.

### BRIEF DESCRIPTION OF THE DRAWINGS

FIG. 1 illustrates a drill;

FIG. 2 is a cross section through a drill head;

FIG. 3 is a bottom view of the drill head from FIG. 1;

FIG. 4 is a bottom view of another drill head; and

FIG. 5 is a bottom view of another drill head.

### DETAILED DESCRIPTION OF THE DRAWINGS

Unless otherwise indicated, the same or functionally equivalent elements are identified by the same reference numbers in the figures.

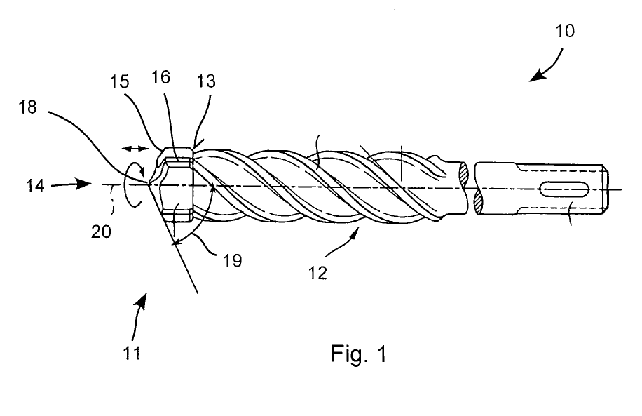

FIG. 1 shows an example of a drill 10. The drill 10 is comprised of a drill head 11 and a shank 12. The shank 12 is configured in the form of a helix. The drill head 11 is connected to the shank 12 at a joining zone 13.

The drill head 11 is made of a hard metal. The hard metal can be, for example, from the class of sintered tungsten carbines. The tungsten carbide is present as grains with, for example, a diameter in the range of 0.8 to 10 μm. A binder material, for example, cobalt, nickel, is added, for example, in a proportion of less than 20%.

The drill head 11 has cutting edges 15, 16 on a front side 14. The drill head 11 preferably has a first cutting edge 15 and a second cutting edge 16, which are inclined with respect to one another at an angle. The angle can be in a range of 60 degrees to 90 degrees. The cutting edges 15, 16 can taper towards a tip 18. An average slope 19 of the cutting edges 15, 16 to an axis 20 of the drill head 11 lies for example in a range of 70 degrees to 90 degrees. The average slope 19 can be determined by a straight line applied to the tip 18 and the edge.

The shank 12 may be made of steel.

The drill head 11 and the shank 12 are first manufactured separately and subsequently attached to one another. In the case of the manufacturing method for the drill head 11, first a green compact of grains and the binder material are pressed into a preform, then the green compact is sintered. The shank 12 may be manufactured, for example, in a metal-cutting method or by rolling.

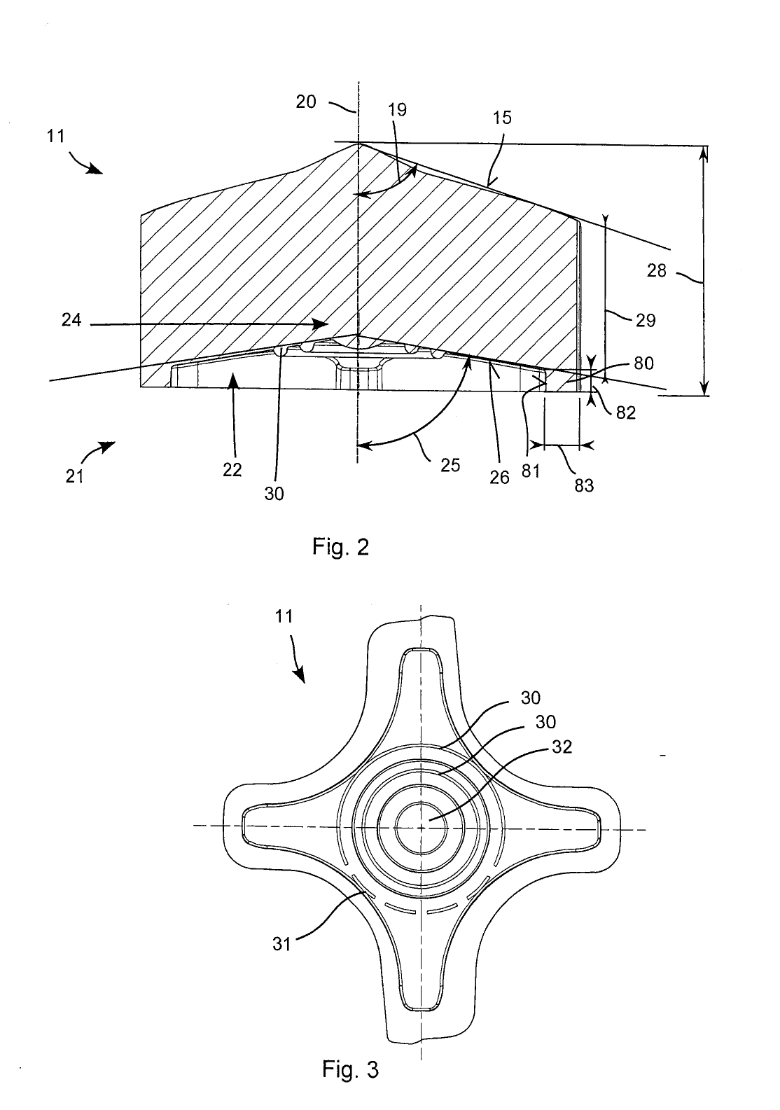

FIG. 2 and FIG. 3 depict an embodiment of a drill head 11 in a section along the axis 20 of the drill head 11 and in a view of an underside 21 of the drill head 11.

A depression 22 can be introduced in the underside 21 of the drill head 11. The depression 22 represents at least 80 percent of the entire cross section of the drill head 11. The depression 22 can taper conically towards the axis 20 of the drill head 11. The cone-shaped lateral area of the depression 22 may be inclined at an angle 25 in the range of 75 degrees to 85 degrees with respect to the axis 20. A slope 25 of the depressed surface 26 can be selected similar to an average slope 19 of the cutting edges 15, 16. A deviation of the slopes may be less than 25 percent, preferably less than 20 degrees. A thickness or strength 29 of the drill head 11, measured along the axis 20, is preferably essentially equal at every distance from the axis 20, preferably at least in the area of the cutting edges 15, 16. A variance of the thickness in the area of the cutting edges 15, 16 is less than 20 percent, preferably less than 10 percent of the average thickness.

A seam 80 may be provided on the underside 21, which preferably comprises the depression 22 completely. The seam 80 runs along the outer contour of the drill head 11. The seam 80 has an inner edge 81. The inner edge 81 can run parallel to the axis 20. However, the edge 81 preferably runs at a slope of 20 degrees to 40 degrees to the axis 20. A height 82 of the seam is approximately in the range of 10 percent to 20 percent of the total height of the drill head 11. A width of the seam 83 is approximately in the range of 5 percent to 10 percent of the diameter of the drill head 11.

Annular elevations 30 are configured on the depressed surface 26. The elevations 30 are arranged concentrically around the axis 20 of the drill head 11. The elevations 30 and the drill head 11 are preferably made of the same material. The elevations 30 can be impressed into the underside 21 before the green compact is sintered.

The elevations 30 preferably have an approximately semicircular cross section. A height of the elevations 30 can be in the range between 0.1 mm and 2 mm. The height of the elevations 30 can be up to fifteen percent of a height 28 of the drill head 11. A width of the elevations 30 accordingly is preferably in a range of 0.2 mm to 4.0 mm. The elevations 30 preferably have no edges, and a radius of curvature of the elevations is preferably greater than 0.1 mm in each direction. A dome-shaped elevation 32 can be arranged on the axis 20 of the drill head 11. The dome-shaped elevation 32 preferably has a similar height as the elevations 30, i.e., in the range of 0.05 mm to 0.5 mm. Its diameter can lie, for example, between 2 mm and 4 mm.

The elevations 31 may also be interrupted along the circular line, as indicated in FIG. 3 for example. In particular, an opening may be provided along the circular line in the plane of the cutting edges 15, 16 and axis 20.

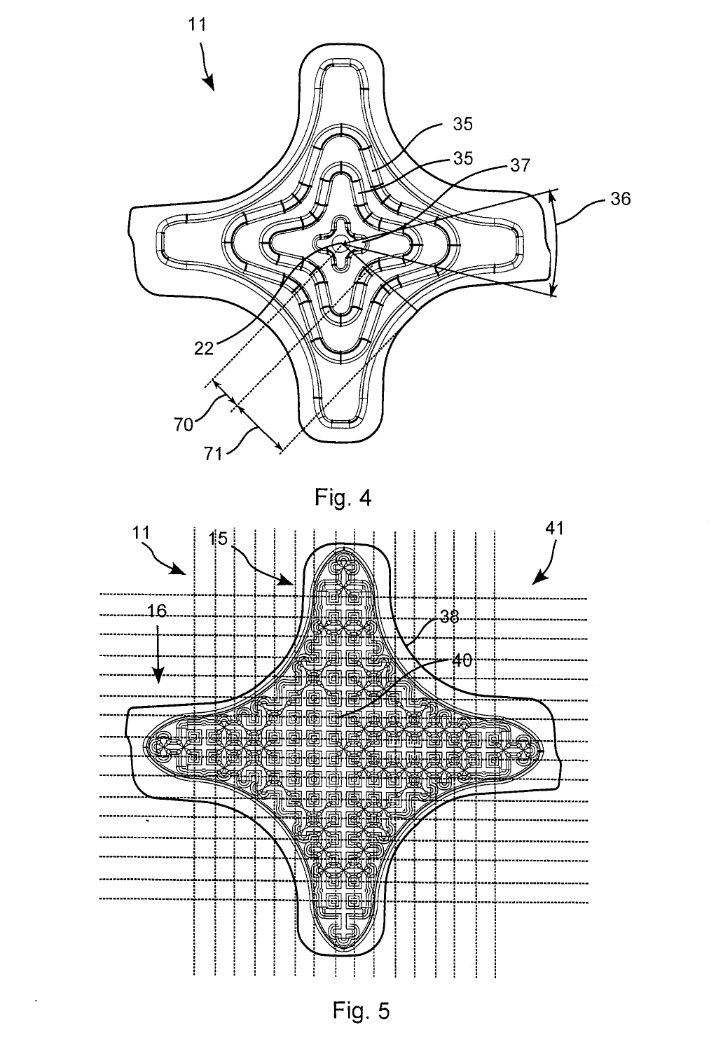

FIG. 4 depicts a variant of an underside with elevations 35. The elevations 35 are annular. A contour of the elevations 35 follows the star-shaped geometry of the drill head 11. A radial distance of the elevations 35 from the axis 20 of the drill head 11 in angular areas 36 of the cutting edges is greater than in other areas. The radial distance from the axis 20 to the edge of the drill head 11 is divided into two sections 70, 71 by the elevation 35 in every angular direction, and the sections have a fixed aspect ratio to one another. In the area of the axis 20, a star-shaped elevation 37 may be arranged, the cross section of which has, for example, the same shape as the circumference of the drill head. The elevation 35 can be interrupted multiple times along its line. In particular the elevation 35 can be interrupted along axes parallel to the cutting edges 15, 16.

FIG. 5 shows a variation of an underside 38 with a plurality of elevations 40. The elevations are arranged on intersections of a grid 41. The lines of the grid 41 are preferably parallel to the first cutting edge 15 or parallel to the second cutting edge 16 of the drill head. In the depicted exemplary embodiment, the first cutting edge 15 and the second cutting edge 16 are perpendicular to each other. In the case of other geometries of the drill head 11, the cutting edges run at angles in a range of 60 degrees to 90 degrees.

The elevations 40 are limited in both directions of the grid 41. At least ten discrete elevations 40 are arranged along the greatest dimensions, i.e. in the plane of the cutting edges 15, 16. Inner thermo-mechanical stress after the welding process can be reduced by the elevations 40. In this case, it was shown that a large number of elevations 40 has a more beneficial effect than a small number, and larger elevations are more beneficial as well. A crack penetrating in the area of low stress must worker harder to penetrate the joining zone.

The elevations 40 can also be arranged along lines running radially on the underside of the drill head 11 instead of on a grid 41. The elevations 40 can be interrupted multiple times along the radial lines or extend over the entire length.

Instead of providing elevations that project from the underside, depressions may also be sunk into the underside.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A drill, comprising:
a drill head made of hard metal; and
a shank made of steel;
wherein an underside of the drill head is fastened integrally to the shank, and wherein the underside is curved inwardly in a cone-shaped manner.

2. The drill according to claim 1, wherein the drill head is joined with the shank.

3. The drill according to claim 1, wherein a slope of the underside deviates by less than twenty degrees from a slope of a cutting edge of the drill head.

4. The drill according to claim 1, wherein a deviation of a thickness of the drill head in a plane through a cutting edge and an axis is less than twenty percent of an average thickness of the drill head.

5. The drill according to claim 1, wherein a surface of the shank facing the drill head has a convex curvature.

6. The drill according to claim 5, wherein the curvature represents at least eighty percent of a cross section of the shank.

7. The drill according to claim 1, wherein the underside has depressions and/or elevations, wherein a height of the depressions and/or elevations is a maximum of fifteen percent of a height of the drill head.

8. The drill according to claim 7, wherein a ratio of a width of the depressions and/or elevations to the height is between 0.5 and four.

9. The drill according to claim 7, wherein a radius of curvature of surfaces of the depressions and/or elevations is greater than 0.1 mm in each direction.
